(19) United States
(12) Patent Application Publication
(10) Pub. No.: US 2010/0146221 A1
(43) Pub. Date: Jun. 10, 2010

(54) Method For Protecting Memory Data

(76) Inventors: Bei-Chuan Chen, Hsinchu (TW); Li-Hsiang Chan, Hsinchu (TW); Shih-Hsien Yang, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/329,544

(22) Filed: Dec. 6, 2008

(51) Int. Cl. G06F 12/14

(52) U.S. Cl. 711/154; 711/E12.091

(57) ABSTRACT

A method for protecting memory data is provided, by extracting bad block addresses stored in the bad block information obtained during the memory scanning testing as memory label, and using an algorithm to compute an identification based on the memory label so that the memory will check the identification and whether the blocks pointed by memory label being bad blocks when an external device request data reading so as to prevent the unauthorized data from being read and achieve the object of protecting memory data.

### FIELD OF THE INVENTION

The present invention generally relates to a method for protecting memory data, and more specifically to a method for using the address of damaged blocks as label and identification to protect the stored data from unauthorized access.

### BACKGROUND OF THE INVENTION

As the information industry progresses rapidly, the use of storage devices is more popular and the capacity also increases. Many types of storage devices are currently used as data storage interface; thus, the data security issue also becomes prominent.

The current methods for protecting data in the storage device use password protection, such as by using password to accessed protected files. Only when the password is correct, the storage device allows the PC access the stored data. Or, the stored data is encrypted with the password, so that when the file is accessed but without password for decryption, the file cannot be used directly. Another common way to protect data is to use the file system features, by using the public file system format to implant specific file or identification to specific reserved area so as to monitor the external access to the memory data and prevent data from unauthorized duplication.

The disadvantage of conventional techniques is that any method relying on software to protect storage data can also be compromised by software approaches. In addition, the file system features for protection is also valid for protecting data on a single storage device and fails to prevent data duplication using physical address, i.e., using the duplication machine to perform a one-to-one data copying based on memory address. Take a flash memory stick as an example. When duplicating a flash memory stick from another in a burning method, the files system protection is compromised.

Therefore, it is imperative to devise a memory data protection method based on the hardware characteristics of the memory to solve the disadvantages of the conventional software protection approaches.

### SUMMARY OF THE INVENTION

The primary object of the present invention is to provide a method for protecting memory data, by extracting the bad block addresses detected during memory scanning from the storage bad block information as the memory label, i.e., the hardware label of the memory. Then, a specific algorithm is used to compute an identification from the bad block addresses so that the memory will check the identification and the bad block addresses when an external access to the memory data occurs so as to prevent memory data from the unauthorized data duplication or accesses.

Another object of the present invention is to provide a method for protecting memory data, by selecting a plurality of memory bad block addresses as memory label and using an appropriate function to computer the mean as an identification. The identification and the memory label are stored in a specific memory address. When the data of the memory is duplicated to a second memory and the user try to read data from the second memory, the second memory will compare the identification stored in that specific memory address is the mean computed by the function on the memory label. If correct, a further confirmation is to determine whether the memory label point to the memory bad blocks. If correct again, the memory data is authorized and the access is accessed and transmitted to the user. Otherwise, the memory data is treated as an unauthorized data and further access is not allowed so as to prevent the memory data from authorized duplication.

Therefore, the method for protecting memory data of the present invention can block the loophole of the conventional method that is easily compromised by duplicating based on physical address. The memory data duplicated based on physical address cannot be accessed with the protection method of the present invention.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a flowchart of the writing of memory data of the method for protecting memory data according to the invention;

FIG. 2 shows a flowchart of the reading of memory data of the method for protecting memory data according to the invention; and

FIG. 3 shows a schematic view of the operation of the method for protecting memory data according to the present invention.

### DETAILED DESCRIPTION OF THE PREFERRED EMBODIMENTS

The method for protecting memory data of the present invention includes two stages. The first stage is the writing of the memory data and the second stage is the reading of the memory data. The writing of memory data is to establish a mechanism in the memory for prevent the reading of unauthorized memory data. The reading of memory data is to use the mechanism established in the first stage to determine whether the read memory data is authorized when reading the memory data.

The above method for protecting memory data is to be executed by the access controller of the memory. In other words, the access controller realizes the writing of the memory data to the memory and the reading of the memory data from the memory. The access controller can be a common microprocessor unit (MCU) executing specific firmware to realize the method for protecting memory data. On the other hand, the access controller can also be application specific IC (ASIC) without firmware so that writing and the reading of memory data are realized directly by the hardware circuit. In addition, a plurality of independent electrical elements can also be assembled to form a circuit module to realize the writing and the reading of the memory data. Therefore, the present invention is not limited to any specific embodiment of the access controller.

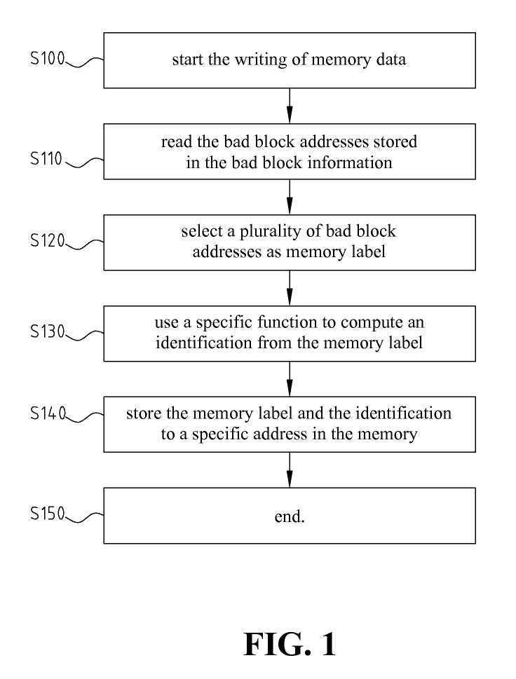

FIG. 1 shows a flowchart for writing of memory data of the method for protecting memory data according to the present invention. As shown in FIG. 1, the writing of memory data process starts with step S100, and enters step S110. Step S110 is to read the bad block addresses stored in the bad block information and enter step S120. Step S120 is to select a plurality of bad block addresses as memory label and enter step S130. Step S130 is to use a specific function to compute an identification from the memory label and enter step S140. Step S140 is to store the memory label and the identification to a specific address in the memory and enter step S150 to terminate.

The bad block information includes all the bad block addresses recorded during the memory scanning test and is stored in a specific address in the memory so that the memory controller can avoid, by referring to the bad block addresses, performing data access to bad blocks. The specific function in step S130 can be any function, such as sum, the mean or the maximum of the selected bad block addresses. It is worth noting that the protecting method of the present invention does not limit the specific function to be of any particular format. Any function that can obtain a value used as an identification from the selected bad block addresses is within the scope of the present invention. Therefore, the specific address for storing memory label and the identification can also be randomly selected as long as it is not a bad block.

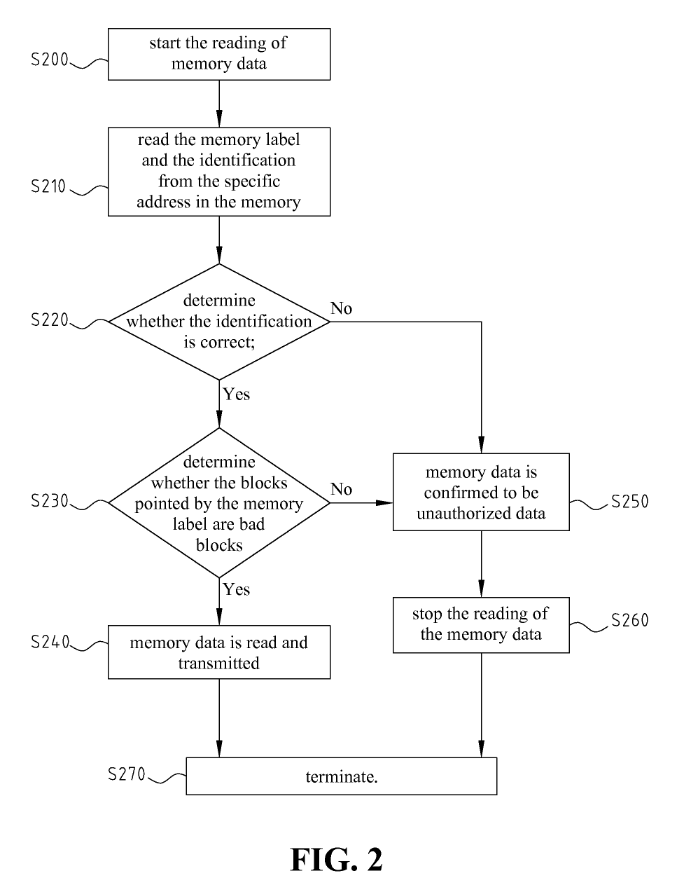

FIG. 2 shows a flowchart of the reading of memory data of the method for protecting memory data according to the present invention. As shown in FIG. 2, the reading of memory data process starts with step S200 for the memory to receive request from external device for reading memory data, and enters step S210. Step S210 is to read the memory label and the identification from the specific address in the memory and enter step S220. Step S220 is to determine whether the identification is correct; if so, the process enters step S230; otherwise, the process enters step S250. Step S230 is to determine whether the blocks pointed by the memory label are bad blocks; if so, the process enters step S240; otherwise, the process enters step S250. In step S240, the memory data is confirmed to be authorized data, and the memory data is read and transmitted, and then the process enters step S270 to terminate. In step S250, the memory data is confirmed to be unauthorized data, and the process enters step S260. Step S260 is to stop the reading of the memory data and enter step S270 to terminate.

The external device in step S200 can be PC, notebook PC or PDA. In step S230, to determine whether a block is a bad block, a value can be written to that memory block first and then read from the block for comparison with the original value written into that memory block. Alternatively, several values can be written to and read from that memory block for comparison. It is worth nothing that the protection method of the present invention does not limit the method of determining of the normalcy of memory block in step S230.

The present invention uses steps S230 and S240 to determine whether the identification is correct and whether the memory blocks pointed by the memory label are bad blocks, in order to confirm that the memory data is authorized data to prevent the unauthorized duplicated memory data from being read.

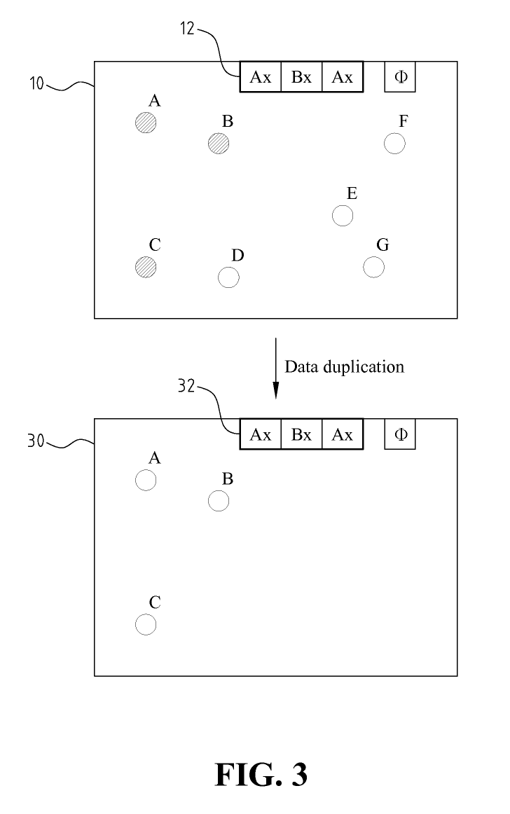

FIG. 3 shows a schematic view of the operation of the method for protecting memory data according to the present invention. As shown in FIG. 3, original memory 10 includes a plurality of bad blocks, such as blocks A, B, C, D, E, F, G, recorded in the stored bad block information. The addresses of bad blocks A, B, C (Ax, Bx, Cx) are selected as memory label 12 for memory 10. The specific function f is used to generate an identification Φ; i.e., f(Ax, Bx, Cx)=Φ. Specific function f can be the sum, mean or the maximum of above bad block addresses Ax, Bx, Cx. The present invention does not limit the use of any particular function.

It is worth noting that the above embodiment selects three bad block addresses Ax, Bx, Cx as memory label to exemplify the present invention. The present invention does not limit the number of bad block addresses to be selected.

Memory label 12 and identification Φ are stored in a specific address of original memory 10, such as 0x00fd. The other addresses of original memory 10 can be used to store other data. Because original memory 10 has memory label 12 and identification Φ, the data stored in original memory 10 can be viewed as authorized data.

When the data stored in original memory 10, including memory label 12, identification Φ and memory data, are duplicated to duplicated memory 30, duplicated memory 30 also has memory label 32, identification Φ and memory data, where memory label 32 and identification Φ are stored in specific address 0x00fd, and the memory data is stored in corresponding addresses, i.e., identical to original memory 10.

Specific function f performs computation on memory label 32, i.e., f(Ax, Bx, Cx) and the result is compared against Φ. If f(Ax, Bx, Cx) is not equal to Φ, the duplicated data in duplicated memory 30 is not authorized, and the controller must prevent the memory data from being read by external device. If f(Ax, Bx, Cx) is equal to Φ, the next step is to check whether memory blocks A, B, C of duplicated memory 30 are bad blocks. If memory blocks A, B, C are not all bad blocks, the duplicated data in duplicated memory 30 is not authorized, and the controller must prevent the memory data from being read by external device. If memory blocks A, B, C are all bad blocks, the duplicated data in duplicated memory 30 is authorized data, the controller allows the memory data from being read by external device.

It is worth noting that duplicated memory 30 has stored bad block information which is different from the stored bad block information of original memory 10. This is because the memory is fabricated on the wafer by semiconductor manufacturing process, and each wafer has different defects due to the variation of the manufacturing process, i.e., different bad block information. Therefore, memory label 12 and memory label 32 can be used as fingerprints of original memory 10 and duplicated memory 30. That is, the present invention uses the hardware characteristics of the memory as the fingerprint to identify whether the data is authorized.

Therefore, the method of the present invention is to use the hardware characteristics of the memory to identify whether the memory data is authorized so as to prevent the unauthorized duplicated data from being read or used. This also achieves the object of protecting memory data.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A memory data protection method, for protecting memory data of a memory, said method comprising the following steps of:
a writing of memory data, storing a memory label of said memory and an identification based on said memory label computed by a specific function into a specific address of said memory, and then storing said memory data to said memory, where said memory label comprising a plurality of bad block addresses of said memory; and
a reading of memory data, after receiving a data reading request from an external device, reading said memory label of said memory and said identification, comparing a value computed by said specific function based on said memory label against said identification, and checking whether memory blocks of said memory pointed said memory label being bad blocks, if said computed value and said identification being equal and said blocks pointed by said memory label being bad blocks, said memory data stored in said memory being authorized and executing data reading and transmitting to said external device; otherwise, terminating data reading request of said external device.

2. The method as claimed in claim 1, wherein said memory is a flash memory.

3. The method as claimed in claim 1, wherein said specific function is a summation function for summing up said bad block addresses.

4. The method as claimed in claim 1, wherein said specific function is a summation and mean function for summing up the said bad block addresses and computing the mean of said bad block addresses.

5. The method as claimed in claim 1, wherein said specific function is a maximum value function for selecting the maximum value among said bad block addresses.

6. The method as claimed in claim 1, wherein said specific address is the address of a memory block which is not a bad block of said memory.

7. The method as claimed in claim 1, wherein said external device is a PC.

8. The method as claimed in claim 1, wherein said external device is a notebook PC.

9. The method as claimed in claim 1, wherein said external device is a PDA.
